(19) United States
(12) Patent Application Publication
(10) Pub. No.: US 2009/0116845 A1
(43) Pub. Date: May 7, 2009

(54) TETINTELLIGENT OPTICAL TRANSCEIVER CAPABLE OF OPTICAL-LAYER MANAGEMENT

(76) Inventors: Wen Li, Fremont, CA (US); Jianhui Zhou, (US); Wen Huang, Cupertino, CA (US); Fulin Pan, Fremont, CA (US)

Correspondence Address: XIN WEN, 3449 RAMBOW DRIVE, PALO ALTO, CA, 94306, US

(21) Appl. No.: 11/934,222

(22) Filed: Nov. 2, 2007

(51) Int. Cl. H04B 10/00

(52) U.S. Cl. 398/135

(57) ABSTRACT

An integrated optical transceiver includes an optical receiver that receives a first optical signal that comprises input user data and a first modulation signal. The first modulation signal includes first management information. The optical receiver can output a first electrical signal comprising the first modulation signal and to output a second electrical signal comprising the input user data in response to the first optical signal. A processing unit can demodulate the first electrical signal to extract the first management information. The processing unit can produce a modulation control signal in response to second management information. An optical transmitter can output a second optical signal in response to the modulation control signal and a third electrical signal comprising output user data.

### BACKGROUND

The present disclosure relates to optical networking systems and optical transceivers used in the systems.

As the Internet, voice over Internet Protocol (VoIP), and Internet Protocol television (IPTV) grow in popularity, more and more users desire to have access to these services from their premises. Likewise, businesses now require more and more bandwidth delivered to their premises with necessary quality of service. In order to meet the growing bandwidth demand, optical fibers are being laid to cover more areas, often directly linked to the customer premises. Different types of communication equipment such as xDSL, xPON, WDM, ROADM, etc. are being deployed cross optical networks. Service providers' networks are becoming more and more complex than ever before. Network manageability and serviceability are becoming key challenges for service providers to ensure service level agreement (SLA) and guarantee customer satisfaction.

### SUMMARY

In a general aspect, the present specification relates to an integrated optical transceiver that includes an optical receiver configured to receive a first optical signal that includes input user data and a first modulation signal, wherein the first modulation signal comprises first management information, wherein the optical receiver can output a first electrical signal comprising the first modulation signal and to output a second electrical signal comprising the input user data in response to the first optical signal; a processing unit that can demodulate the first electrical signal to extract the first management information, wherein the processing unit can produce a modulation control signal in response to second management information; and an optical transmitter that can output a second optical signal in response to the modulation control signal and a third electrical signal comprising output user data.

In yet another general aspect, the present specification relates to an integrated optical transceiver that includes an optical receiver configured to output a first electrical signal in response to a first optical signal; an optical transmitter that can output a second optical signal in response to a second electrical signal; a reception electrical interface that can output the first electrical signal; and a loop back controller that can route the first electrical signal in at least two directions under the control of a first control signal, wherein the loop back controller can route the first electrical signal to a reception electrical interface or to route the first electrical signal to the optical transmitter.

In yet another general aspect, the present specification relates to an integrated optical transceiver that includes an optical receiver that can receive a first optical signal that comprises input user data and a first modulation signal wherein the first modulation signal comprises first management information, wherein the optical receiver can output a first electrical signal comprising the first modulation signal and to output a second electrical signal comprising the input user data in response to the first optical signal; a processing unit that can demodulate the first electrical signal to extract the first management information, wherein the processing unit can produce a modulation control signal in response to second management information; an optical transmitter that can output a second optical signal at a transmission electrical interface in response to the modulation control signal and a third electrical signal comprising output user data; a transmission electrical interface that can receive the third electrical signal; a reception electrical interface that can output the first electrical signal; and a loop back controller that can route the first electrical signal in at least two directions under the control of a first control signal, wherein the loop back controller can route the first electrical signal to a reception electrical interface or to route the first electrical signal to the optical transmitter.

In yet another general aspect, the present specification relates to optical communication system that includes a first optical transceiver module and a second optical transceiver module. The first optical transceiver module can include a first transmitter that can output a downstream optical signal in response to a downstream modulation control signal and a first downstream electrical signal comprising downstream user data; and a first receiver that can receive an upstream optical signal, wherein the upstream optical signal comprises upstream user data and a upstream modulation signal carrying upstream management information, wherein the first optical receiver can output a first electrical signal comprising the upstream modulation signal and to output a first upstream electrical signal comprising the upstream user data; a first processing unit configured to produce the downstream modulation control signal in response to downstream management information and configured to demodulate the first electrical signal to extract the upstream management information. The a second optical transceiver module can include a second receiver configured to receive the downstream optical signal and output a second electrical signal comprising the downstream modulation control signal and a second downstream electrical signal comprising the downstream user data; a second processing unit that can demodulate the second electrical signal to extract the downstream management information and to produce an upstream modulation control signal in response to the upstream management information; and a second transmitter that can output the upstream optical signal in response to the upstream modulation control signal and a second upstream electrical signal comprising the upstream user data.

In yet another general aspect, the present specification relates to a method for optical communication. The method includes outputting a downstream optical signal by a first transmitter in response to a downstream modulation control signal and a first downstream electrical signal comprising downstream user data; receiving, by a first receiver, an upstream optical signal, wherein the upstream optical signal comprises upstream user data and a upstream modulation signal carrying upstream management information; outputting a first electrical signal comprising the upstream modulation signal by the first optical receiver; outputting a first upstream electrical signal comprising the upstream user data by the first optical receiver; producing the downstream modulation control, signal by a first processing unit, in response to downstream management information; demodulating the first electrical signal to extract the upstream management information by the first processing unit; receiving the downstream optical signal by a second receiver; outputting, by the second receiver, a second electrical signal comprising the downstream modulation control signal and a second downstream electrical signal comprising the downstream user data; demodulating the second electrical signal to extract the downstream management information by a second processing unit; producing an upstream modulation control signal by the second processing unit in response to the upstream management information; and outputting the upstream optical signal by a second transmitter in response to the upstream modulation control signal and a second upstream electrical signal comprising the upstream user data.

Implementations of the system may include one or more of the following. The second optical signal can include an envelop modulation based on the modulation control signal and comprising the second management information. The optical transmitter can produce the second optical signal under the control of a bias current, wherein the bias current can be responsive to the modulation control signal. The first modulation signal can include an envelop modulation of the first optical signal. The integrated optical transceiver can further include a micro controller configured to send the second management information to the processing unit and receives the first management information from the processing unit. The micro controller can produce at least a portion of the second management information in response to the first management information. The integrated optical transceiver can further include a control interface, wherein the micro controller receives at least a portion of the second management information at the control interface and sends the first management information to the control interface. The integrated optical transceiver can further include a reception electrical interface that can output the second electrical signal; and a transmission electrical interface that can input the second, electrical signal; wherein the reception electrical interface and the transmission electrical interface comply with a standard selected from the group consisting of GBIC, SFF, SFP, XFP, X2, XENFAK and SFP+.

Embodiments may include one or more of the following advantages. The disclosed systems and methods provide more reliable communications by direct and reliable monitoring of optical communications by establishing an optical layer communication channel that is non-intrusive to the user data traffic. The disclosed systems and methods can eliminate the needs for demarcation equipment in some conventional optical network systems. The functions of the optical transceivers are enriched by functions integrated in an optical transceiver, which include non-intrusive optical communication channel, optical layer management, and data feedback capability. These functions are not available in the conventional optical transceivers.

Moreover, optical layer management is provided without adding overhead to the user data and the host equipment into which the disclosed optical transceivers are plugged. The disclosed system and methods do not require costly implementation such as digital wrapper or extra interoperable equipment at customer premises. Furthermore, the disclosed optical transceiver is a device that is compliant with industry-standard optical transceiver formats and can be implemented as a passive device which receives electric power from the host equipment into which it is plugged.

Although the specification has been particularly shown and described with reference to multiple embodiments, it will be understood by persons skilled in the relevant art that various changes in form and details can be made therein without departing from the spirit and scope of the specification.

### BRIEF DESCRIPTION OF THE DRAWINGS

FIG. 1 is a block diagram for an optical network system including a pair of transceivers over a point-to-point fiber link.

FIG. 2 is a block diagram for an optical network system including smart optical transceivers.

FIG. 3 illustrates an exemplified optical network system having pluggable smart optical transceivers.

FIG. 4 is an exemplified block diagram of a smart optical transceiver having integrated optical-layer management capability.

FIG. 5 is an exemplified block diagram of a smart optical transceiver having integrated optical-layer management capability and data loop back function.

### DETAILED DESCRIPTION

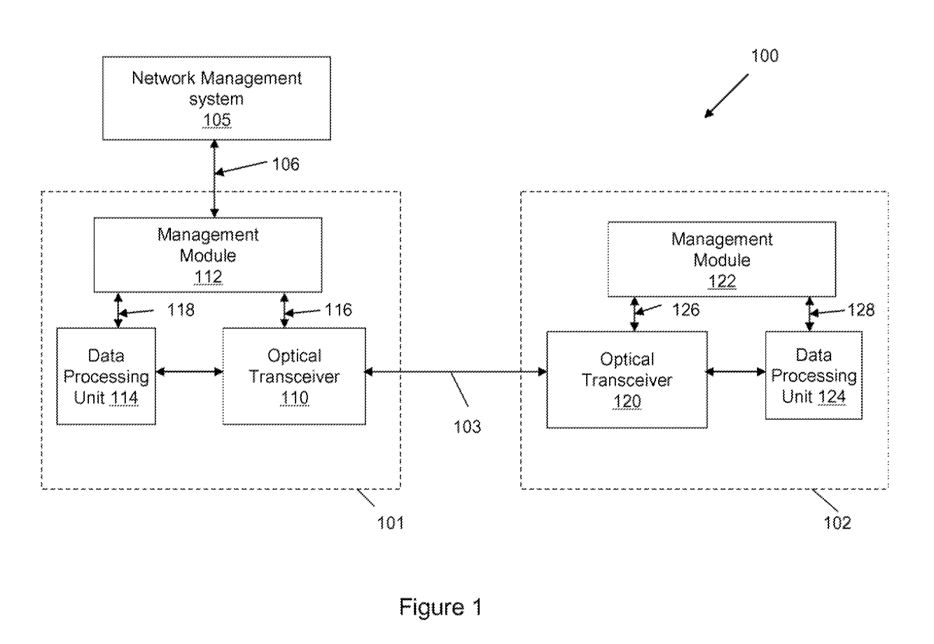

Referring to FIG. 1, an optical network system 100 includes network equipment 101 and 102 that are at different locations and can communicate in optical signals via an optical link 103. The optical link 103 can for example include a single optical fiber, or a cable containing a bundle of optical fiber. The equipment 101 includes an optical transceiver 110 that can perform conversions between optical and electrical signals, a data processing unit 114 that processes communication signals, and a management module 112 that monitors and controls the functions of the network equipment 101. Similarly, the equipment 102 includes an optical transceiver 120 that can perform conversions between optical and electrical signals, a data processing unit 124 that processes the communication signals, and a management module 122 that monitors and controls the functions of the network, equipment 102. Usually, a higher level network management system 105 manages entire network system 100.

The optical network system 100 can, for example, be a telecommunication or internet service providers' network. The network equipment 101 can be located at a service provider's central facility and managed by the network management system 105 via the management module 112. The interface 106 between the network management system 105 and the management module 112 can include for example a RS232 consol, an Ethernet port, and other types of interfaces. The network, equipment 102 can be at a remote location such as a customer premise. While the network management system 105 manages the equipment 101 locally, it can only manage the equipment 102 remotely. In some embodiments, in the downstream direction (from the central office to the customer premise), the management information can be transported through the optical link 103 from network management system 105 to the management module 112, and then sent to the data processing unit 114 via a communication interface 118. The data processing unit 114 processes the downstream management information, and then sends electrical signals comprising both user data and the downstream management information to the optical transceiver 110. In the present specification, the term “user data” refers to the data that carries information to be communicated between for example the service provider and customers. For example, “user data” can include video data, voice data, and email data communicated between different points in an optical communication network.

The management module 112 can also communicate directly with the optical transceiver 110 via a communication interface 116. The optical transceiver 110 converts the electrical signals to downstream optical signals. The optical transceiver 120 receives the downstream optical signals via the optical link 103 and converts the downstream optical signals to electrical signals. The data processing unit 124 can extract downstream management information from the electrical signals from the optical transceiver 120, and send the downstream management information to the management module 122 via a communication interface 128. In the upstream direction, the upstream management information can take a reverse path from the management module 122 to the network management system 105 via the data processing unit 124, the optical transceiver 120, the optical transceiver 110, the data processing unit 114, and the management module 112.

In the above described arrangement, the management data and user data share the bandwidth of the optical link 103 between the network equipment 101 and 102. This communication mode of management information can be referred to as “in-band” channel. The “in-band” management can be implemented as dedicated management overhead in data frames such as Ethernet OAM (operation, administration and management), or as a digital wrapper that encapsulates user data, in the latter case, the resulting data rate traversing optical link 103 is higher than the user data rate. The “in-band” channel can include several drawbacks. First, in the case of dedicated management overhead in data frames, the bandwidth for the user data is decreased by the bandwidth allocated to the management data, in case of digital wrapper, a complicated and expensive data processing chip must be added to the system. Secondly, the equipment 101 and the equipment 102 have to be fully interoperable. The interoperability does not always exist because the network equipment 101 and 102 in real world networks are usually of different vintages and of different grades (carrier-grade vs. enterprise grade), owned and operated by different parties (e.g. service providers and customers), with different maintenance practices (carrier-grade vs. enterprise grade). These lead to the lack of complete and consistent interoperability. To solve this problem, the industry has adopted the practice of installing extra interoperable equipment, owned and maintained by service providers, at customer premises, just for the sake of guaranteed interoperability. This practice is apparently very costly in terms of both capital expenditure and operational expenditure.

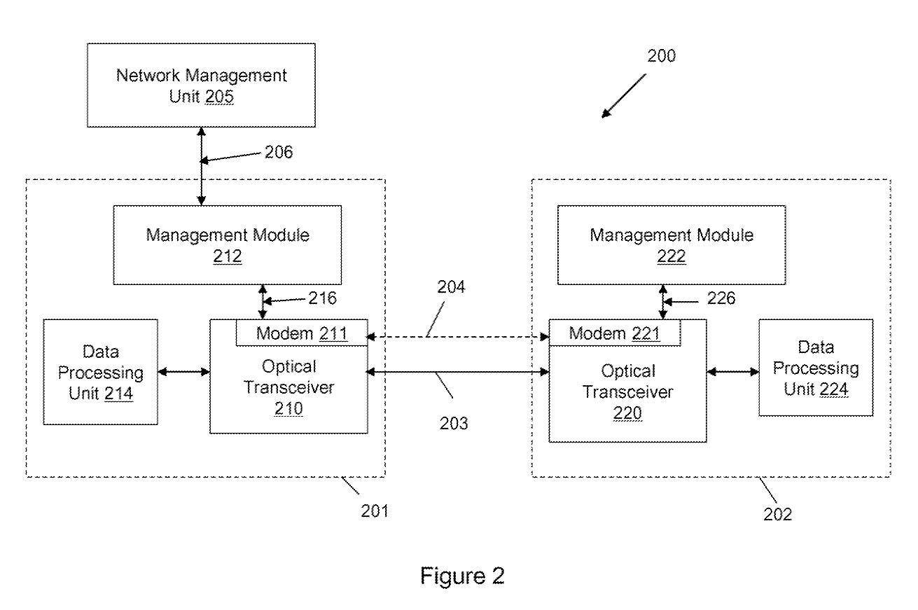

In some embodiments, referring to FIG. 2, an optical communication system 200 includes network equipment 201 and 202 that are at different locations and connected via an optical link 203. The equipment 201 includes a smart optical transceiver 210, a data processing unit 214 that processes communication data, and a management module 212 that monitors and controls the network equipment 201. Similarly, the equipment 202 includes a smart optical transceiver 220, a data processing unit 224 that processes communication data, and a management module 222 that monitors and controls the network equipment 202.

The optical transceivers 210 and 220 respectively include modems 211 and 221 that can apply and retrieve non-intrusive modulation on the downstream and upstream data signals between the optical transceivers 210 and 220. In general, the modem 211 and 221 are

processing units that can perform modulation and demodulation functions. The modulation and demodulation functions can be implemented as an integrated circuit or software application stored as firmware on a memory. The processing unit can include one or more processing devices.

In the present, specification, the term “non-intrusive modulation” refers to a modulation that has negligible impact on user data between optical transceivers in an optical communication system. For example, non-intrusive modulation can include a relatively low frequency small amplitude envelope modulation on optical data signals. Here the envelope refers to the trace of the maximum amplitudes of the optical data signals. The optical data signals can be used as a carrier for a secondary modulation that changes the amplitude of the envelope slowly compared to the bit-rate of the carrier. The amplitudes of the envelope modulation can be kept small relative to the optical signals for user data. It is understood that the small-amplitude envelop modulation of user data signals is only an exemplified, implementation. The disclosed system and methods can utilize other modulation and demodulation techniques, such as and not limited to, frequency modulation and phase modulation.

In contrast to the “in-band” communication method described earlier, the modulation and demodulation of the optical signals by the integrated optical modems 211 and 221 has negligible impact on the transmission of user data. The data packets and data rate of the user data stay unchanged through the optical link 203. In other words, the optical modems 211 and 221 can achieve “transparent” or “out-of-band” management in the optical communication system 200 in a manner that is non-intrusive. The link 204 between the optical modems 211 and 221 is a communication channel. The two optical transceivers 210 and 220 can be referred to as smart optical transceivers in the present specification because they include much intelligence that is non-existent in generic transceivers.

A network management unit 205 manages the entire optical communication system 200. Downstream management information in the optical communication system 200 is sent from the network management unit 205 to the management module 212 through a management interface 206. The management interface 206 can be a RS232 consol, an Ethernet port, or other type of interfaces. The downstream management information is then sent to smart optical transceiver 210 via a communication interface 216, which can he an I²C (inter-integrated circuit) interface. The optical modem 211 in the smart optical transceiver 210 processes the downstream management information. The optical modem 211 then applies a non-intrusive modulation containing management information to the downstream optical signal produced by the smart optical transceiver 210. After traveling through the optical link 203, the downstream optical signal is received by the optical transceiver 220. The optical modem 221 extracts the downstream management information from the downstream optical signal by demodulating the downstream optical signal. The downstream management information is then sent to the management module 222 via a communication interface 226. Similarly, the upstream management information can take a reverse path from the management module 222 to the network, management unit 205 via the optical transceiver 220, the optical transceiver 210, and the management module 212. The optical communication system 200 thus can provide services to customer with extensive management capabilities that is transparent and non-intrusive to user data.

Management data signal can be generated by the management modules 212, 222 and the optical transceivers 210, 220. The optical transceivers 210 and 220, for example, can periodically report current transmission and reception optical powers, which can be used to analyze link qualities of downstream and upstream fibers. When a significant degradation occurs over time, a warning message can be sent to the network management unit 205. Besides the status monitoring of the optical transceiver 210, 220, the management modules 212, 222 can also monitor other status in the equipment 201, 202. For instance, the operation status of data processing unit 224 can be reported, to the network management unit 205 through the non-intrusive management channel.

In some embodiments, the network management unit 205 produces at least a portion of the downstream management signal in response to the upstream management signal extracted by the modem 211. For example, when the equipment 202 is first powered up and connected to the equipment 201, the management module 222 can generate registration request information and send it to modem 211 through the link 204. The registration request information is extracted by the modem 211 and sent, to the network management unit 205, which produces an acknowledge message to be returned to the management module 222.

The optical communication system 200 provides communication channels for management data in the optical layer (or Layer 1) without the need of transferring and processing management data in upper layers. The optical communication system 200 and other disclosed systems and methods can thus provide “optical layer management”. In the present specification, the phrase “optical layer management” refers to the system management arrangement wherein management data are generated, processed, and transported at optical layer. Optical layer management does not cause changes to the transmission of user data. For instance, the transmission speed, data format, and contents (overhead and payload) of the user data are not affected by the presence of optical layer management.

The network equipment at the central office and the optical cables are usually owned by the service providers. The network equipment at the remote site is often owned and managed by customers. Network management and status monitoring can become difficult when the two pieces of network equipment are owned and operated by separate parties, and have different level of compliance to the “in-band” management standards. More importantly, the cost of network maintenance is high because of many “truck rolls” (which refers to the dispatch of service technicians, with necessary diagnostic tools, equipment, and sparing parts to field or customer premises for locating and fixing problems). When a network problem arises, it is desirable for service provider personnel to access, or be alerted by, from its own facilities, the network management system that determines the failure points and causes for the failures. To accomplish such, it requires service providers to have capabilities of monitoring and diagnosing not only the equipment located at service providers' facilities, but also the equipment at customer premises.

In some cases, service providers can deploy demarcation equipment at customer premises to achieve the needed remote manageability. Demarcation equipment is a network terminal equipment (NTE) that is owned by service provider, can thereby communicate with equipment located at service provider's facility with full interoperability. Management data can be inserted into and retrieved from user data by the demarcation equipment. Demarcation equipment, while adds costs, can help manage the optical network, reduce operational expenditure and enforce service level agreement (SLA).

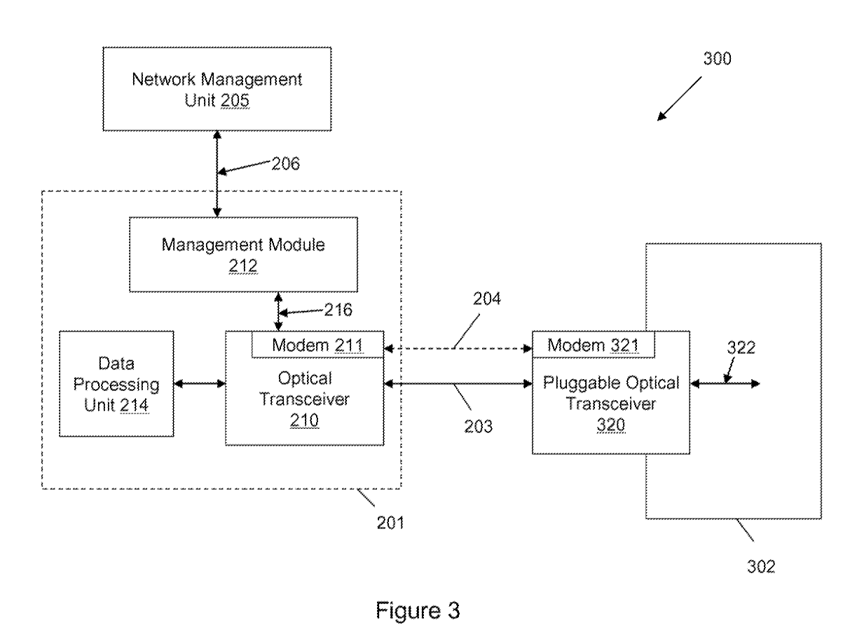

The disclosed smart optical transceivers can eliminate the need for such demarcation equipment, thus providing simplicity, flexibility, and lowered costs in the construction and maintenance of the optical communication network. In some embodiments, referring to FIG. 3, an optical communication system 300 includes a network equipment 201 located at a service provider's facility, a pluggable smart optical transceiver 320 plugged into a network equipment 302 that is at a remote site such as a customer premise. The pluggable optical transceiver 320 can communicate with the network equipment 302 via an electrical interface 322. For example, the network equipment 302 can be an enterprise Ethernet switch. The pluggable optical transceiver 320 can be an SEP (small form-factor pluggable) optical transceiver that includes an integrated modem as described above and can be plugged into a standard SFP socket on the enterprise Ethernet switch in this case, the electrical, optical, mechanical and control interfaces of the optical transceiver comply with the MSA (multi-source agreement) specifications. The smart optical transceiver can be made to be compliant with other industry standards and specifications such as GBIC, SFF, SFP, XFP, X2, XENPAK and SFP+.

The network equipment 201 includes a smart optical transceiver 210, a data processing unit 214 that processes communication data, and a management module 212 that monitors and controls the network equipment 301. The smart optical transceiver 210 is in optical communication with the pluggable optical transceiver 320 via optical link 203. The smart optical transceiver 210 includes a modem 211 and the pluggable optical transceiver 320 includes a modem 321. In some embodiments, the optical transceiver 210 can also be pluggable to network equipment at a central office. As described above, the management of the network equipment 201 and the network equipment 302 can be communicated through the modems 211 and 321 through the non-intrusive management channel 204. In some embodiments, the management data can be carried by relatively low speed and relatively small amplitude envelope modulation over optical signals carrying the user data and retrieved by demodulation. While the smart optical transceiver 320 is visible and managed by the network management unit 205, the network equipment 302 at the remote site may be invisible to the network management unit 205.

Management data signals in the optical communication system 300 can be generated by various communication devices or components such as the network management unit 205, the management module 212, the smart optical transceiver 210, and the pluggable optical transceiver 320. The equipment 302, a host of the pluggable optical transceiver 320, is often owned by a different party. As described above, the equipment 302 does not need to contribute to optical layer management. Thus, the optical communication system 300 can cost-effectively provide optical layer OAM without requiring demarcation equipment or full interoperability with the network equipment at the customer premises.

In some embodiments, the mechanical, optical, and electrical interface 322 of the pluggable optical transceiver 320 complies with standard MSA specifications such as GBIC, SEP, XFP, X2, XENPAR and SFP+, etc . . . it allows optical management to be implemented without altering the network equipment 302. In some embodiments, the pluggable optical transceiver 320 can be a passive device without its own power supply. The pluggable optical transceiver 320 can receive power at its standard pins electrical interface 322 from the network equipment 302.

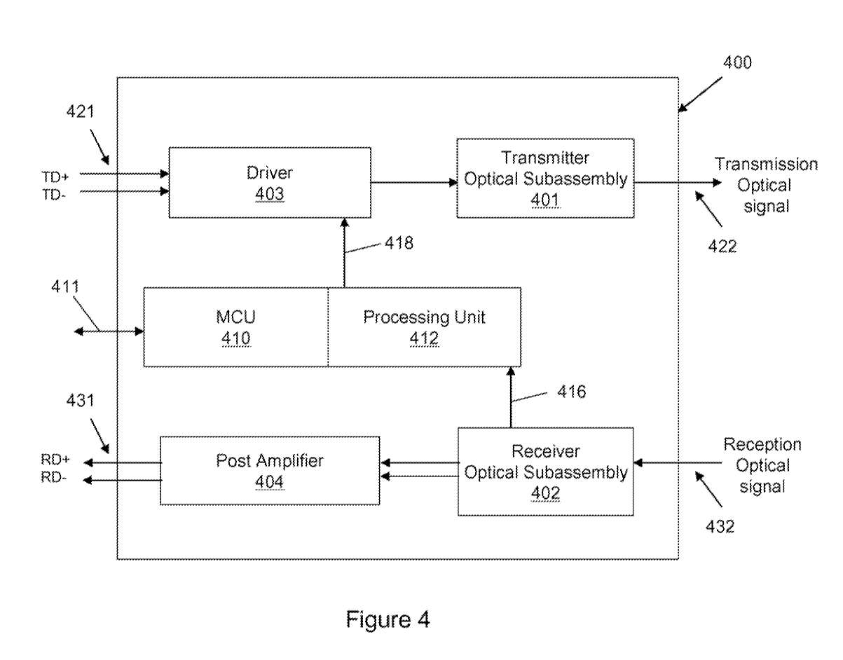

FIG. 4 illustrates a smart optical transceiver 400 having non-intrusive management channel capabilities, which is compatible with the optical transceivers 210, 220, and 320 in the optical communication systems 200 and 300. A driver 403 such as a laser driver receives differential data signals TD+ and TD− carrying user data for transmission at a transmission electrical interface 421. A transmitter optical subassembly (TOSA) 401 can emit optical output signals at a transmission optical interface 422 driven by the driver 403. A reception optical signal at a reception optical interface 432 can be converted to reception electrical signals by a receiver optical subassembly (ROSA) 402 and further amplified by a post amplifier 404 to output differential data signals RD+ and RD− at a reception electrical interface 431. A micro controller unit (MCU) 410 can monitor and control the operation of the optical transceiver 400. The MCU 410 can output status and other signals and receive control signals at an interface 411. A processing unit 412 is integrated inside the optical transceiver 400 to facilitate the non-intrusive optical-layer management communication with another remote optical transceiver, as discussed above in relation to FIGS. 2 and 3. In some embodiments, the processing unit 412 can be Implemented as a modem integrated inside the transceiver 400. In some embodiments, the processing unit 412 and the MCU 410 can be implemented as a modem integrated, inside the transceiver 400. The processing unit 412 can either be implemented as an electric circuit or implemented fully or partially by software stored in computer memories such as firmware. The processing unit 412 is closely connected with the MCU 410 to facilitate fast transfer of the management data to the MCU 410 for data processing. The processing unit 412 is in communication with the driver 403. It should he understood that the transmission signal received by the driver and the reception signals output by the post amplifier are not limited to differential signals. Both signals can also be compatible with single-ended signals.

In the transmission path, the processing unit 412 can send a modulation control signal 418 containing management information to the driver 403. Usually the modulation control signal 418 is a low speed signal for example a few tens kilobit per second comparing to transmission user data received at the transmission electrical interface 421, which can be more than one gigabit per second. In some embodiments, the modulation control signal 418 can modulate bias voltage or current in the driver 403 to produce a low speed and small amplitude envelope modulation over the differential data signals (TD+ and TD−). In the reception path, the ROSA 402 can send a signal 416 to the processing unit 412 in response to the reception optical signal. A low speed and small amplitude modulation in the reception optical signal 416 can carry the management data. Usually signal 416 is a low speed signal for example a few tens kilobit per second comparing to reception electrical user data output signal form the ROSA 402, which can be more than one gigabit per second. For example, the signal 416 can be a mirror photo-current signal produced at the ROSA 402. The processing unit 412 can demodulate the signal 416 and extracts the management, data. Thus, the smart optical transceiver 400 has the capability to transmit and receive non-intrusive management data. The extracted, management data can be processed by MCU 410 or passed to host equipment for the optical transceiver 400 through the interface 411. For example, the optical transceiver 400 can be used in place of the optical transceiver 210 in the optical communication system 200 or 300. The optical transceiver 400 can be at an OLT (optical line terminal) located at service provider's facility. The management data can be sent out through the interface 216 and processed by the management module 212. In another example, the optical transceiver 400 can be located at a remote location away from the service provider's facility. The optical transceiver 400 can be a pluggable optical transceiver connected to third party equipment as shown in FIG. 3. The MCU 410 can perform as the central unit of processing and generating management data.

It should be understood that the disclosed optical transceiver can include components other than the ones described above in the optical transceiver 400. For instance, the disclosed optical transceiver can include functional blocks such as CDR (clock data recovery), SerDes (Serializer Deserializer), and other functional blocks. Moreover, the driver 403 can be a laser diver chip or an external modulator that can modulate continuous wave optical signals from TOSA 401.

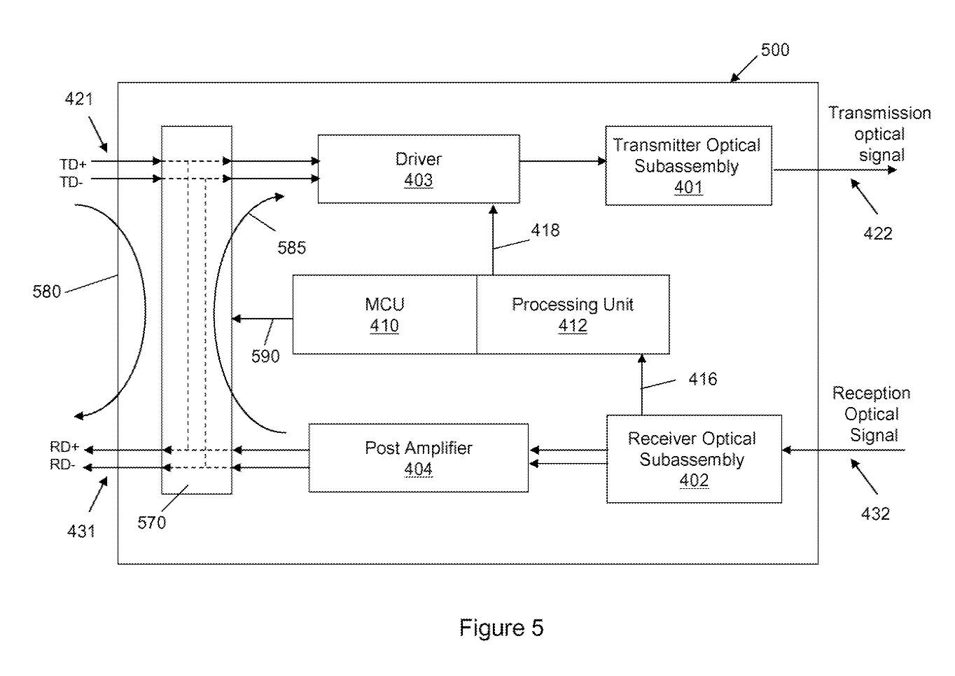

Data loop back test is a useful tool for a service provider to debug and locate network faults. It can help service providers to avoid unnecessary “truck rolls” and reduce operational expenditure. FIG. 5 illustrates a smart optical transceiver 500 compatible with the optical transceivers 210, 220, and 320 in the optical communication systems 200 and 300. The smart optical transceiver 500 includes non-intrusive management channel similar to the above-described in relation with the smart optical transceiver 400. The smart optical transceiver 500 includes an integrated loop back controller 570 that can receive differential data signals (TD+, TD−) for transmission at a transmission electrical interface 421. The loop back controller 570 can also output reception data (RD+, RD−) at a reception electrical interface 431. The loop back controller 570 can work under default bypass condition, in which the differential data signals (TD+, TD−) for transmission are directly passed to the driver 403 and the reception data (RD+, RD−) are also directly transmitted from the post amplifier 404.

The MCU 410 can output status signals and receive control signals at an interface 411 to the outside (not shown in FIG. 5). The MCU 410 can send a control signal 590 to control the loop back controller 570 to different loop back modes including local loop back and remote loop back. In the local loop back mode, differential data (TD+, TD−) for transmission are routed inside loop back controller 570 back to the reception electrical interface (along path 580). The routed back signals can be used to verify the proper operation of network equipment into which the smart optical transceiver 500 is plugged. In the remote loop back mode, the output of the post amplifier 404 is routed back to the driver 403 through the loop back controller 570 (along path 585). The driver 403 and the TOSA 401 can produce a transmission optical signal that replicates the reception optical signal received at the reception optical interface 432. The replicated optical signals in the remote loop back mode can allow a service provider to remotely verify the working conditions of both the optical link to and fro, the optical transceiver 500 and the optical transceiver 500 itself.

Embodiments may include one or more of the following advantages. The disclosed systems and methods provide more reliable communications by direct and reliable monitoring of optical communications by establishing an optical layer communication channel that is non-intrusive to the user data traffic. The disclosed systems and methods can eliminate the needs for demarcation equipment in some conventional optical network systems. The functions of the optical transceivers are enriched by the non-intrusive optical communication channel, data feedback capability and other enhanced capabilities integrated in an optical transceiver. These functions are not available in the convention optical transceivers. Moreover, optical layer management is provided without adding overhead to the user data and the host equipment. The disclosed system and methods do not require costly implementation such as digital wrapper or extra interoperable equipment at customer premises. Furthermore, the disclosed optical transceiver is a device that is compliant with industry-standard optical transceiver formats and can be implemented as a passive device which receives electric power from the host equipment.

It is understood that the specific configurations and parameters described above are meant, to illustration the concept of the specification. The disclosed systems and methods can be compatible with variations of configurations and parameters without deviating from the spirit of the present invention. For example, it is understood that the low-amplitude envelop modulation of user data signals is only an exemplified implementation. The disclosed system and methods can utilize other modulation and demodulation techniques, such as and not limited to, frequency modulation and phase modulation.

What is claimed is:

1. An integrated optical transceiver, comprising:
an optical receiver configured to receive a first optical signal that comprises input user data and a first modulation signal, wherein the first modulation signal comprises first management information, wherein the optical receiver is configured to output a first electrical signal comprising the first modulation signal and to output a second electrical signal comprising the input user data in response to the first optical signal;
a processing unit configured to demodulate the first electrical signal to extract the first management information, wherein the processing unit is configured to produce a modulation control signal in response to second management information; and
an optical transmitter configured to output a second optical signal in response to the modulation control signal and a third electrical signal comprising output user data.

2. The integrated optical transceiver of claim 1, wherein the second optical signal includes an envelop modulation based on the modulation control signal and comprising the second management information.

3. The integrated optical transceiver of claim 2, wherein the optical transmitter produces the second optical signal under the control of a bias current, wherein the bias current is responsive to the modulation control signal.

4. The integrated optical transceiver of claim 1, wherein, the first modulation signal includes an envelop modulation of the first optical signal.

5. The integrated optical transceiver of claim 1, further comprising a micro controller configured to send the second management, information to the processing unit and receives the first management information from the processing unit.

6. The integrated optical transceiver of claim 5, wherein the micro controller is configured to produce at least, a portion of the second, management information in response to the first, management information.

7. The integrated optical transceiver of claim 5, further comprising a control interface, wherein the micro controller receives at least a portion of the second management information at the control interface and sends the first management information to the control interface.

8. The integrated optical transceiver of claim 1, further comprising;
a reception electrical interlace configured to output the second electrical signal; and
a transmission electrical interface configured to input the second electrical signal; wherein the reception electrical interface and the transmission electrical interface comply with a standard selected from the group consisting of GBIC, SFF, SEP, XFP, X2, XENPAK and SFP+.

9. An integrated optical transceiver, comprising:
an optical receiver configured to output a first electrical signal in response to a first optical signal;
an optical transmitter configured to output a second optical signal in response to a second electrical signal;
a reception electrical interface configured to output the first electrical signal; and
a loop back controller configured to route the first electrical signal in at least two directions under the control of a first control signal, wherein the loop back controller is configured to route the first electrical signal to a reception electrical interface or to route the first electrical signal to the optical transmitter.

10. The integrated optical transceiver of claim 9, wherein the optical transmitter is configured to output the second optical signal in response to the first electrical signal routed from the optical receiver by the loop back controller.

11. The integrated optical transceiver of claim 9, further comprising a transmission
electrical interface configured to receive the second electrical signal, wherein the loop back controller is configured to route at least portions of the second electrical signal from the transmission electrical interface to the reception electrical interface under the control of a second control signal.

12. The integrated optical transceiver of claim 11, further comprising a micro controller configured to send the first control signal and the second control signal to the loop back controller.

13. The integrated optical transceiver of claim 11, wherein the reception electrical interface and the transmission electrical interface comply with a standard selected from the group consisting of GBIC, SFF, SFP, XFP, X2, XENPAK and SFP+.

14. An Integrated optical transceiver, comprising;
an optical receiver configured to receive a first optical signal that comprises input user data and a first modulation signal, wherein the first modulation signal comprises first management information, wherein the optical receiver is configured, to output a first, electrical signal comprising the first modulation signal and to output a second electrical signal comprising the input user data in response to the first optical signal;
a processing unit configured to demodulate the first electrical signal to extract the first management information, wherein the processing unit is configured to produce a modulation control signal in response to second management information;
an optical transmitter configured to output a second optical signal in response to the modulation control signal and a third, electrical signal comprising output user data;
a transmission electrical interface configured to receive the third electrical signal;
a reception electrical interface configured to output the first electrical signal; and
a loop back controller configured to route the first electrical signal in at least two directions under the control of a first control signal, wherein the loop back controller is configured to route the first electrical signal to a reception electrical interface or to route the first electrical signal to the optical transmitter.

15. The integrated optical transceiver of claim 14, wherein the second optical signal includes an envelop modulation based on the modulation control signal and comprising the second management information, wherein the first modulation signal includes an envelop modulation of the first optical signal.

16. The integrated optical transceiver of claim 14, further comprising a micro controller configured to send the second management information to the processing unit and receives the first management information from the processing unit, and configured to send the first control signal to the loop back controller.

17. The integrated optical transceiver of claim 16, wherein the micro controller is configured to produce at least a portion of the second management information in response to the first management information.

18. The integrated optical transceiver of claim 14, wherein the reception electrical interface and the transmission electrical interface comply with a standard selected from the group consisting of OBIC, SFF, SFP, XFP, X2, XENPAK and SFP+.

19. An optical communication system, comprising:
a first optical transceiver module, comprising:
a first transmitter configured to output a downstream optical signal in response to a downstream modulation control signal and a first downstream electrical signal comprising downstream user data; and
a first receiver configured to receive an upstream optical signal, wherein the upstream optical signal comprises upstream user data and a upstream modulation signal carrying upstream management information, wherein the first optical receiver is configured to output a first electrical signal comprising the upstream modulation signal and to output, a first, upstream electrical signal comprising the upstream user data;
a first processing unit configured to produce the downstream modulation control signal in response to downstream management information and configured to demodulate the first electrical signal to extract the upstream management information;
a second optical transceiver module, comprising:
a second receiver configured to receive the downstream optical signal and output a second electrical signal comprising the downstream modulation control signal and a second downstream electrical signal comprising the downstream user data;
a second processing unit configured to demodulate the second electrical signal to extract the downstream management Information and to produce an upstream modulation control signal in response to the upstream management information; and
a second transmitter configured to output the upstream optical signal in response to the upstream modulation control signal and a second upstream electrical signal comprising the upstream user data.

20. The optical communication system of claim 19, further comprising a network management unit configured to receive the upstream management information from the first processing unit and to produce at least a portion of the downstream management information in response to the upstream management information.

21. The optical communication system of claim 19, wherein the first optical transceiver module is pluggable into a first host device, wherein the first optical transceiver module is configured to receive the downstream user data from the first host device.

22. The optical, communication system of claim 21, wherein the second optical transceiver module is pluggable into a second host device, wherein the second optical transceiver module is configured to receive the upstream user data from the second, host device.

23. A method for optical communication, comprising:
outputting a downstream optical signal by a first transmitter in response to a downstream modulation control signal and a first downstream electrical signal comprising downstream user data;
receiving, by a first receiver, an upstream optical signal, wherein the upstream optical signal comprises upstream user data and a upstream modulation signal carrying upstream management information;
outputting a first electrical signal comprising the upstream modulation signal by the first optical receiver;
outputting a first upstream electrical signal comprising the upstream user data by the first optical receiver;
producing the downstream modulation control signal by a first processing unit in response to downstream management information;
demodulating the first electrical signal to extract the upstream management information by the first processing unit;
receiving the downstream optical signal by a second receiver;
outputting, by the second receiver, a second electrical signal comprising the downstream modulation control signal and a second downstream electrical signal comprising the downstream user data;
demodulating the second electrical signal to extract the downstream management information by a second processing unit;
producing an upstream modulation control signal by the second processing unit in response to the upstream management information; and
outputting the upstream optical signal by a second transmitter in response to the upstream modulation control signal and a second, upstream electrical signal comprising the upstream user data.

24. The method of claim 23, further comprising producing at least a portion of the downstream management information in response to the upstream management information extracted by the first processing unit.

25. The method of claim 23, wherein the first receiver, the first transmitter, and the first processing unit are housed in a first unitary optical transceiver module, wherein the second receiver, the second transmitter, and the second processing unit are housed in a second unitary optical transceiver module.
